(19) United States
(12) Patent Application Publication
(10) Pub. No.: US 2024/0198629 A1
(43) Pub. Date: Jun. 20, 2024

(54) DEGRADABLE COMPOSITE NON-WOVEN FABRIC AND FABRICATION METHOD THEREFOR

(71) Applicant: XIAMEN YANJAN NEW MATERIAL CO., LTD, Fujian (CN)

(72) Inventors: Chao Sheng WU, Fujian (CN); Shi Huang LI, Fujian (CN); Yong Gong CHEN, Fujian (CN)

(21) Appl. No.: 18/288,194

(22) PCT Filed: Jan. 27, 2022
(86) PCT No.: PCT/CN2022/074240

§ 371 Date: Oct. 25, 2023

(30) Foreign Application Priority Data
Jul. 19, 2021 (CN) 202110813822.1

(51) Int. Cl. B32B 5/26; B32B 7/08

(52) U.S. Cl. CPC B32B 5/268; B32B 7/08; B32B 2262/0284; B32B 2305/20; B32B 2307/716

(57) ABSTRACT

A degradable composite non-woven fabric being a layered structure with an upper surface layer, an intermediate fiber layer, and a lower surface layer in sequence. The upper and lower surface layers are mainly composed of degradable melt-blown fibers. The intermediate fiber layer is mainly composed of degradable water-absorbing fibers, wherein the weight of fibers of the intermediate layer accounts for more than 65% of the total weight of the composite non-woven fabric, and there are fiber interwoven regions between the upper surface layer and the intermediate fiber layer, as well as between the lower surface layer and the intermediate fiber layer.

### TECHNICAL FIELD

The present invention relates to the technical field of non-woven fabrics, and in particular to a degradable wiping non-woven fabric that is applied in personal care and infant care, and a manufacturing method therefor.

### BACKGROUND OF THE INVENTION

Wiping non-woven fabrics have gained popularity among consumers due to their convenience in carrying, storage, and use. Currently, wiping non-woven fabrics can be spunlace non-woven fabric products, or they can be melt-blown non-woven fabrics or spunbond non-woven fabrics. Compared to traditional cloth wipes, the production of wiping non-woven fabrics is convenient and cost-effective, and these fabrics are suitable for both dry and wet usage. However, in existing melt-blown and spunbond non-woven fabrics, the melt-blown surface layers are often made of pliable and moldable high polymers such as polypropylene. Since these polymers are hard to degrade or decompose in the natural environment after being used, these polymers can cause severe environmental pollution. The presence of such non-degradable high polymers in the soil can negatively affect water and nutrient absorption by crops, leading to reduced crop yields. When being disposed of in landfills, these materials occupy land and take hundreds of years to degrade. Therefore, with the increasing use of wiping non-woven fabrics, the waste is also increased, and the degradation problem becomes increasingly pronounced.

### BRIEF SUMMARY OF THE INVENTION

### Technical Problems to be Solved

It is an object of the present invention is to provide a degradable composite wiping non-woven fabric and a manufacturing method therefor, thereby overcoming the defects of existing products and production methods.

### Technical Solutions to the Technical Problems

### Technical Solutions

To achieve the aforementioned object, the present invention provides a degradable composite wiping non-woven fabric with a layered structure, comprising sequentially an upper layer, a middle fiber layer, and a lower layer; the upper layer and the lower layer of the degradable composite wiping non-woven fabric are mainly formed by degradable melt-blown fibers, and the middle fiber layer is mainly formed by degradable absorbent fibers; wherein a weight of the middle fiber layer is more than 65% of a total weight of the degradable composite wiping non-woven fabric, and there are fiber interlacing and intertwining areas between the upper layer and the middle fiber layer, as well as between the lower layer and the middle fiber layer.

The degradable melt-blown fibers are fibers made from polylactic acid, polybutylene adipate terephthalate (PBAT), or a mixture thereof.

The degradable melt-blown fibers are degradable single-component fibers, degradable bi-component melt-blown fibers in which each strand of fiber has an outer surface at least partially formed by a low-melting-point resin, or a mixture thereof.

The degradable bi-component melt-blown fibers are degradable bi-component sheath-core type melt-blown fibers, degradable bi-component orange peel type melt-blown fibers, or degradable bi-component side-by-side type melt-blown fibers.

The middle fiber layer mainly comprises viscose fibers, wood pulp fibers, or mixed fibers formed by a mixture of the viscose fibers and the wood pulp fibers.

A weight percentage of the viscose fibers in the mixed fibers of the middle fiber layer is greater than or equal to 15%.

A method for manufacturing a degradable composite wiping non-woven fabric, comprising the following steps: (1) carding the degradable absorbent fibers into a fiber web using a carding machine or opening and loosening the degradable absorbent fibers by a loosening roller; forming the middle fiber layer from the degradable absorbent fibers carded into the fiber web or from the degradable absorbent fibers being opened and loosened through a nozzle under action of auxiliary airflow; wherein the middle fiber layer is mainly formed by viscose fibers, wood pulp fibers, or a mixed fibers formed by a mixture of the viscose fibers and the wood pulp fibers;

(2) employing a melt-blown process, wherein a degradable thermoplastic resin is heated and melted; melt trickles of the degradable thermoplastic resin heated and melted are ejected out from spinnerets, and hot air is used to blow the melt trickles ejected out from the spinnerets into fiber bundles of 3 μm to 8 μm, which, together with flows of the hot air, form melt-blown fiber webs that intertwine with two sides of the middle fiber layer respectively, thereby forming a degradable multilayer fiber web with two outer layers being melt-blown fiber web layers respectively and a middle layer being the middle fiber layer formed by the degradable absorbent fibers in between the melt-blown fiber web layers;

(3) consolidating the degradable multilayer fiber web with a heating device to form the degradable composite wiping non-woven fabric with upper and lower layers being the melt-blown fiber web layers respectively and a middle layer being the middle fiber layer formed by the degradable absorbent fibers.

The heating device is a hot air oven, a pair of press rollers, or a combination thereof.

### Beneficial Effects of the Present Invention

### Beneficial Effects

According to the aforementioned structures and manufacturing method, since the upper and lower layers of the composite wiping non-woven fabric are formed by degradable melt-blown fibers, and the absorbent fibers of the middle fiber layer are also degradable absorbent fibers, the entire composite wiping non-woven fabric is degradable. This addresses the issue of traditional wiping non-woven fabrics using pliable and moldable high polymers such as polypropylene as the melt-blown surface layers, which are hard to degrade or decompose in the natural environment and cause severe environmental pollution. Compared to traditional wiping non-woven fabric waste disposal methods such as incineration and burning, the degradable composite wiping non-woven fabric of the present invention can be disposed in landfills and decompose in the soil, and the produced carbon dioxide directly enters into organic matters in the soil or is absorbed by plants, without being emitted into the atmosphere, thereby avoiding greenhouse effect.

### BRIEF DESCRIPTION OF THE DRAWINGS

FIG. 1 is a schematic diagram of the manufacturing of the degradable composite wiping non-woven fabric according to Embodiment 1 of the present invention.

FIG. 2 is a cross-sectional view of the degradable composite wiping non-woven fabric made according to Embodiment 1 of the present invention.

FIG. 3 is a schematic diagram of the manufacturing of the degradable composite wiping non-woven fabric according to Embodiment 2 of the present invention.

FIG. 4 is a cross-sectional view of the degradable composite wiping non-woven fabric made according to Embodiment 2 of the present invention.

FIG. 5 is a schematic diagram of the manufacturing of the degradable composite wiping non-woven fabric according to Embodiment 3 of the present invention.

FIG. 6 is a cross-sectional view of the degradable composite wiping non-woven fabric made according to Embodiment 3 of the present invention.

### DETAILED DESCRIPTION OF THE INVENTION

### Embodiments of the Present Invention

In order to further explain the technical solutions of the present invention, the present invention will be described in detail with some specific embodiments.

### Embodiment 1

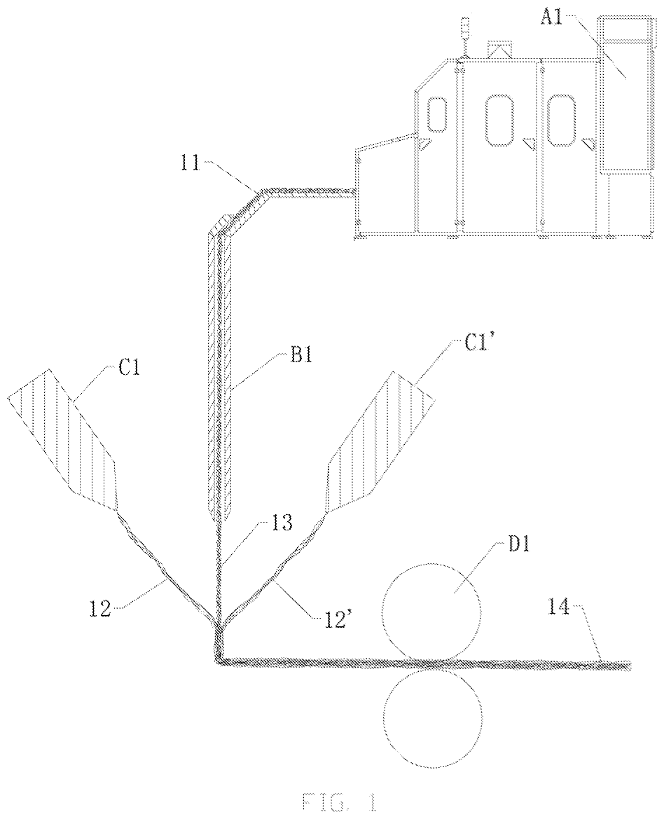

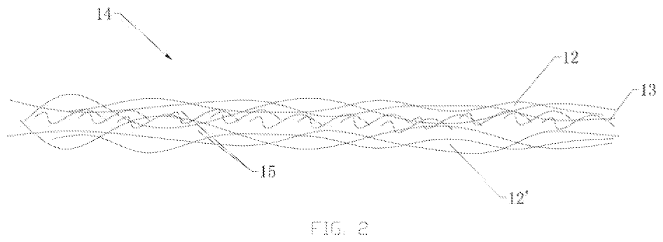

As shown in FIGS. 1 and 2, viscose fibers are carded into a viscose fiber web 11 using a carding machine A1. A middle fiber layer 13 composed of viscose fibers, which are made of degradable absorbent fibers, is formed from the viscose fiber web through a nozzle 61 under action of auxiliary airflow.

By employing a melt-blown process, a polylactic acid is heated and melted; melt trickles of the heated and melted polylactic acid are ejected out from spinnerets C1 and C1′, and hot air is used to blow the melt trickles ejected out from the spinnerets C1 and C1′ into ultra-fine fiber bundles, which, together with flows of the hot air, form melt-blown fiber webs 12 and 12′ that intertwine with two sides of the middle fiber layer 13 respectively, thereby forming a multilayer fiber web with two outer layers being the melt-blown fiber web layers 12 and 12′ respectively and a middle layer being the middle fiber layer 13 formed from the viscose fiber web 11 in between the melt-blown fiber web layers 12 and 12′; melt-blown fibers in the melt-blown fiber web layers are degradable single-component polylactic acid fibers; a weight of the viscose fibers is 75% of a total weight of the degradable composite wiping non-woven fabric.

Fiber web layers of the multilayer fiber web are consolidated by a pair of press rollers D1 to form the degradable composite wiping non-woven fabric 14 with an upper layer and a lower layer being the melt-blown fiber web layers 12 and 12′ respectively, and a middle layer being the middle fiber layer 13 formed from the viscose fiber web 11 in between the upper layer and the lower layer, wherein fiber interlacing and intertwining areas exist between a first melt-blown fiber web layer 12 and the middle fiber layer, and also between a second melt-blown fiber web layer 12′ and the middle fiber layer 13.

### Mechanical Property Testing.

Tensile strength testing was conducted using the XLW-100N Intelligent Electronic Tensile Tester with the following test parameters.
MD (machine direction): sample width: 50 mm, gauge length: 200 mm, stretching velocity: 100 min/min.
CD (cross direction): sample width: 50 mm, gauge length: 100 mm, stretching velocity: 100 m/min.

### Biological Decomposition Rate.

Degradable materials refer to materials that, under appropriate and time-frame-specified natural environmental conditions, can be completely decomposed by microorganisms such as bacteria, fungi, and algae into low molecular compounds, without causing adverse environmental effects. A degradation degree of materials is usually expressed by a degradation index.

Currently, the main method internationally used to assess the biodegradability of plastics is composting. Composting contains a rich source of microorganisms, which to a certain extent can macroscopically reflect the biodegradability of plastics in natural environments,

### Testing Environment.

Culturing of microorganisms should be carried out in containers or rooms, in darkness or weak light, without any steam that might affect microbial growth, and maintained at a constant temperature of 58±2° C.

### Reagents.

Thin-layer chromatography (TLC) cellulose, activated vermiculite.

### Instruments.

Composting container, total organic carbon analyzer, balance.

### Testing Steps.

1. Prepare three composting containers for test samples, that is, weigh 200 g (dry weight) of the activated vermiculite and 50 g (dry weight) of test sample for each composting container, mix and then place them into each composting container.

2. Prepare another three empty composting containers, that is, weigh 200 g (dry weight) of the activated vermiculite and place them into each of said three other composting containers.

3. Place all the composting containers above in a testing environment at 58±2° C., and aerate them with air saturated with water and devoid of carbon dioxide. Specifically, pass air through a wash bottle filled with sodium hydroxide solution to obtain the desired air saturated with water and devoid of carbon dioxide. Oscillate all the composting containers once a week to prevent hardening and ensure sufficient contact between the microorganisms and the test samples.

4. Measure contents of carbon dioxide in emitted gas emitted from each of the composting containers regularly using the total organic carbon analyzer during the testing period. Specifically, during the biological decomposition phase, measure at least twice a day with a time interval of approximately 6 h; in the stable phase, measure at least once a day.

5. The composting cycle should not exceed 6 months. If significant and obvious biological decomposition can still be observed, the test cycle should be extended until a constantly stable phase is reached; if the stable phase occurs prematurely, the test cycle can be shortened.

Calculate a theoretical carbon dioxide release (ThCO₂) in gram (g).

ThCO₂=M_{TOT}×C_{TOT}×44/12.

In the formula: M_{TOT} represents a total dry solid weight in grams (g) in the test sample added to a corresponding composting container at the beginning of the test; C_{TOT} represents a ratio of total organic carbon to the total dry solid weight in the test sample in gram per gram (g/g); 44 and 12 represent molecular weight of carbon dioxide and atomic weight of carbon, respectively.

Calculate a biological decomposition percentage (Dₜ) (%): Dₜ=[(CO₂)_{T}−(CO₂)_{B}]/ThCO₂×100.

In the formula: (CO₂)_{T} represents an accumulated carbon dioxide emissions from each composting container with the test sample mixed with the reagents, in gram per container (g/container); (CO₂)_{B} represents an average accumulated carbon dioxide emissions from the empty composting containers (i.e. those containers without the test sample), in gram per container (g/container); ThCO₂ represents the theoretical carbon dioxide release from the test sample, in gram per container (g/container).

Based on the calculated biological decomposition percentages, biological decomposition curves of all test samples (relationship curves between biological decomposition percentages and time) were plotted. An average value of biological decomposition rate was read from flat portions of the biological decomposition curves, and was recorded as the biological decomposition rate of the tested material.

The tests and their methods are used to test the degradable composite wiping non-woven fabric produced according to Embodiment 1 and a conventional wiping non-woven fabric; wherein the conventional wiping non-woven fabric has both upper and lower surface layers being melt-blown non-woven fabric layers and a middle layer formed by wood pulp fibers. The test results are shown below.

| | | | | Elongation | | Biological | |
|---|---|---|---|---|---|---|---|
| | Gram | Tensile strength | | at break | | decomposition | Days for |
| Test item | weight | MD | CD | MD | CD | rate | decomposition |
| Unit | g/m² | N/2 inch | N/2 inch | % | % | % | g |
| Conventional | 65 | 14.8 | 11.9 | 22.0 | 39.5 | 74.3 | 90 |
| wiping non- | | | | | | | |
| woven fabric | | | | | | | |
| Degradable | 65 | 15.2 | 12.5 | 22.5 | 38.9 | 93.5 | 90 |
| composite non- | | | | | | | |
| woven fabric of | | | | | | | |
| Embodiment 1 | | | | | | | |

As can be seen from the above test results, since the surface layers of the degradable composite non-woven fabric in Embodiment 1 are degradable polylactic acid melt-blown layers, and the middle fiber layer is composed of viscose fibers which are regenerated cellulose fibers, both of these materials can naturally degrade in composting environments, and the produced carbon dioxide directly enters the organic matters in the soil or is absorbed by plants, without being emitted into the atmosphere, thereby avoiding greenhouse effect. This addresses the issue of traditional wiping non-woven fabrics using polypropylene resin as the outer layers which are unable to biodegrade in the natural environment. Moreover, the viscose fibers have a fiber length of approximately 35 mm to 76 mm, whereas the conventional non-woven fabric used for wipes has a middle fiber layer formed by wood pulp fibers with a fiber length of approximately 1 mm to 4 mm. Therefore, the use of viscose fibers with a longer fiber length as the fibers in the middle fiber layer makes it less likely for them to escape from gaps between the melt-blown fibers of the upper and lower layers.

### Embodiment 2

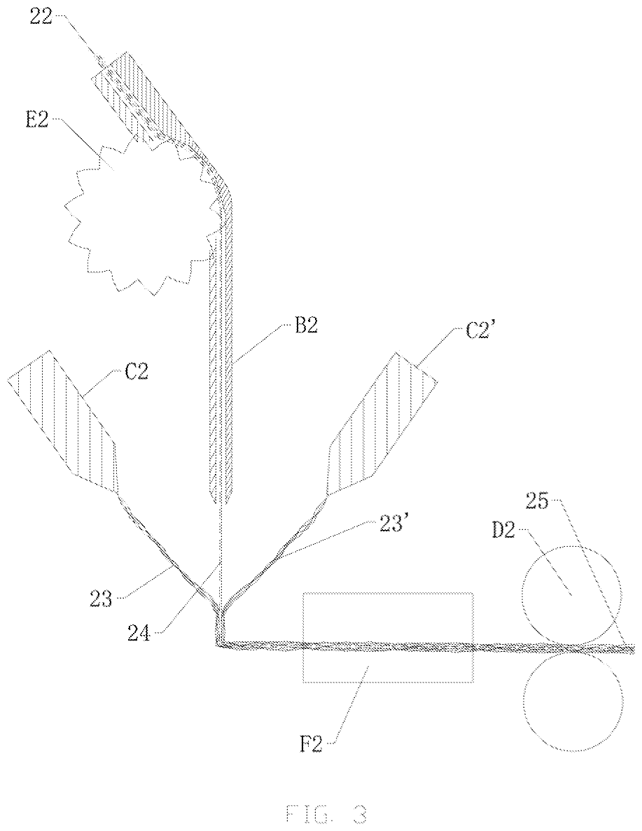

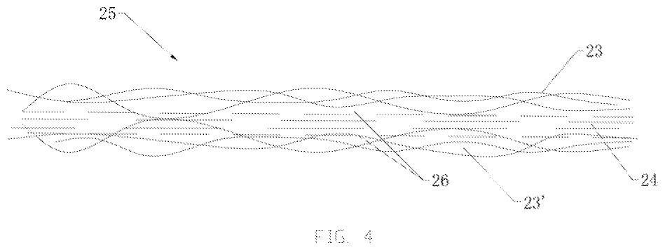

As shown in FIGS. 3 and 4, wood pulp fibers 22 are opened and loosened by a loosening roller E2; a middle fiber layer 24 composed of the wood pulp fibers 22 is formed through a nozzle B2 under action of auxiliary airflow.

By employing a melt-blown process, degradable polybutylene adipate terephthalate (PBAT) is heated and melted; melt trickles of the heated and melted PBAT are ejected out from spinnerets C2 and C2′, and hot air is used to blow the melt trickles ejected out from the spinnerets C2 and C2′ into ultra-fine fiber bundles, which, together with flows of the hot air, form melt-blown fiber web layers 23 and 23′ that intertwine with two sides of the middle fiber layer 24 respectively, thereby forming a multilayer fiber web with two outer layers being the melt-blown fiber web layers 23 and 23′ respectively and a middle layer being the middle fiber layer 24 formed by the wood pulp fibers in between the melt-blown fiber web layers 23 and 23′. As said, melt-blown fibers used in the above described melt-blown process are degradable PBAT fibers, which can be either degradable single-component melt-blown fibers, or degradable bi-component melt-blown fibers; in case of the degradable bi-component melt-blown fibers, the degradable bi-component melt-blown fibers can be degradable bi-component sheath-core type melt-blown fibers, degradable bi-component orange peel type melt-blown fibers, or degradable bi-component side-by-side type melt-blown fibers; a weight of the middle fiber layer is 70% of a total weight of the degradable composite non-woven fabric.

The multilayer fiber web is first put into a hot air oven F2, such that outer surfaces of the degradable bi-component melt-blown fibers in upper and lower layers of the multilayer fiber web can be melted by hot air in the hot air oven to bond the fibers in the upper and lower layers respectively. Then, the multilayer fiber web is further consolidated with a pair of press rollers D2 to form a degradable composite wiping non-woven fabric 25 with the upper and lower layers being the melt-blown fiber web layers 23 and 23′ and a middle layer in between the melt-blown fiber web layers 23 and 23′ being the middle fiber layer 24 formed by the wood pulp fibers 22, wherein fiber interlacing and intertwining areas exist between a first melt-blown fiber web layer 23 and the middle fiber layer 24, and also between a second melt-blown fiber web layer 23′ and the middle fiber layer 24.

The degradable composite non-woven fabric produced in Embodiment 2 and the conventional composite non-woven fabric used for wipes were subjected to testing and evaluation. The test results are shown below.

| | | | | Elongation | | Biological | |
|---|---|---|---|---|---|---|---|
| | Gram | Tensile strength | | at break | | decomposition | Days for |
| Test item | weight | MD | CD | MD | CD | rate | decomposition |
| Unit | g/m² | N/2 inch | N/2 inch | % | % | % | g |
| Conventional | 65 | 14.8 | 11.9 | 22.0 | 39.5 | 74.3 | 90 |
| wiping non- | | | | | | | |
| woven fabric | | | | | | | |
| Degradable | 65 | 16.3 | 12.7 | 22.8 | 39.9 | 95.6 | 90 |
| composite non- | | | | | | | |
| woven fabric of | | | | | | | |
| Embodiment 2 | | | | | | | |

The degradable composite wiping non-woven fabric produced according to the aforementioned structures and manufacturing method has a middle fiber layer 24 formed by wood pulp fibers 22, wherein the wood pulp fibers are degradable absorbent fibers. The upper and lower layers are formed by degradable PBAT melt-blown fibers. Among the degradable materials as mentioned above, PBAT is a terpolymer of terephthalic acid, adipic acid, and butanediol, such that PBAT is easy to process and possesses strong toughness and good biodegradability which allows degradation into carbon dioxide, biomass, and water when being disposed in soil or composting, thereby demonstrating good biodegradability. Further, the produced non-woven fabric feels softer than that made of other fiber materials such as polylactic acid, thereby possessing good elasticity and heat resistance.

### Embodiment 3

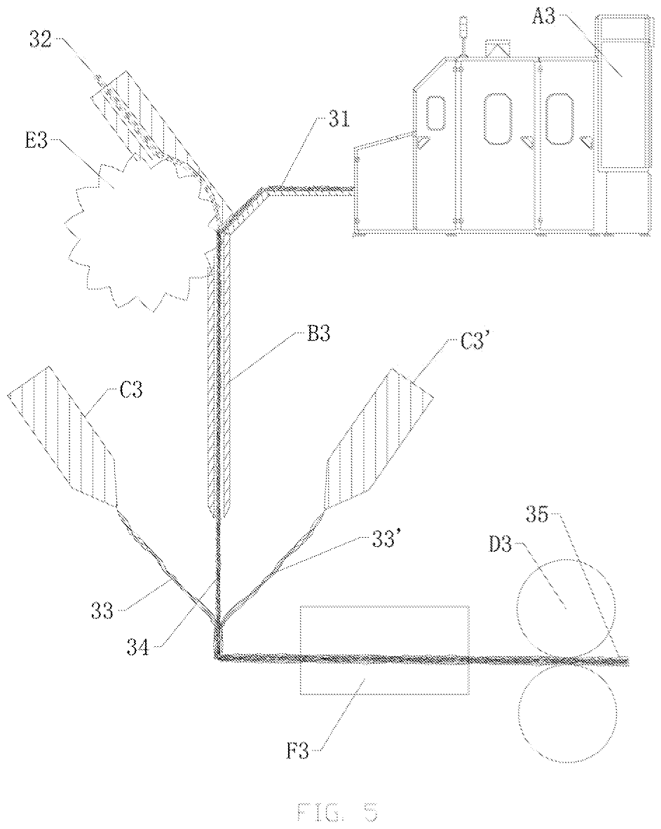

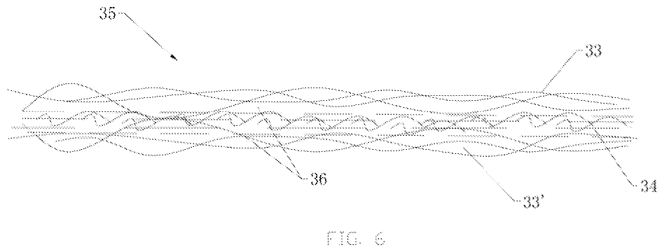

As shown in FIGS. 5 and 6, viscose fibers are carded into a viscose fiber web 31 using a carding machine A3. Wood pulp fibers 32 are opened and loosened by a loosening roller E3; and the wood pulp fibers 32 being opened and loosened are mixed with the viscose fiber web 31 to form a mixture, and then, a middle fiber layer 34 composed of the mixture comprising said wood pulp fibers and the viscose fiber web is formed through a nozzle B3 under action of auxiliary airflow.

By employing a melt-blown process, a mixture comprising 50% by weight of polylactic acid and 50% by weight of PBAT is heated and melted; melt trickles of the heated and melted mixture are ejected out from spinnerets C3 and C3′ and hot air is used to blow the melt trickles ejected out from the spinnerets C3 and C3′ into ultra-fine fiber bundles, which, together with flows of the hot air, form melt-blown fiber webs 33 and 33′ that intertwine with two sides of the middle fiber layer 34 respectively, thereby forming a multilayer fiber web with two outer layers being the melt-blown fiber web layers 33 and 33′ respectively and a middle layer being the middle fiber layer 34 comprising the mixture of the viscose fibers and the wood pulp fibers in between the melt-blown fiber web layers 33 and 33′, melt-blown fibers used in the above described melt-blown process are degradable bi-component melt-blown fibers containing polylactic acid and PBAT, which can specifically be degradable bi-component sheath-core type fibers, degradable bi-component orange peel type fibers, or degradable bi-component side-by-side type fibers; a weight of the middle fiber layer is 80% of a total weight of the degradable composite wiping non-woven fabric; 50% by weight of the middle fiber layer is the viscose fibers; also, besides wood pulp fibers, fibers that can also be mixed with the viscose fibers in the middle fiber layer may be other kinds of degradable absorbent fibers such as cotton fibers.

The multilayer fiber web is first put into a hot air oven F3, such an outer surface, which contains at least partially PBAT resin having a lower melting point than polylactic acid, of each strand of fiber in the degradable bi-component melt-blown fibers in the upper and lower layers of the multilayer fiber web can be melted by hot air in the hot air oven to bond the fibers in the upper and lower layers respectively. Then, the multilayer fiber web is further consolidated with a pair of press rollers D3 to form a degradable composite wiping non-woven fabric 35 with the upper and lower layers being the melt-blown fiber web layers 33 and 33′ and a middle layer in between the melt-blown fiber web layers 33 and 33′ being the middle fiber layer 34 formed by the mixture of the wood pulp fibers 32 and the viscose fiber web 31, wherein fiber interlacing and intertwining areas exist between a first melt-blown fiber web layer 33 and the middle fiber layer 34, and also between a second melt-blown fiber web layer 33′ and the middle fiber layer 34.

The degradable composite non-woven fabric produced in Embodiment 3 and the conventional composite non-woven fabric used for wipes were subjected to testing and evaluation. The test results are shown below.

| | | | | Elongation | | Biological | |
|---|---|---|---|---|---|---|---|
| | Gram | Tensile strength | | at break | | decomposition | Days for |
| Test item | weight | MD | CD | MD | CD | rate | decomposition |
| Unit | g/m² | N/2 inch | N/2 inch | % | % | % | g |
| Conventional | 65 | 14.8 | 11.9 | 22.0 | 39.5 | 74.3 | 90 |
| wiping non- | | | | | | | |
| woven fabric | | | | | | | |
| Degradable | 65 | 15.8 | 12.5 | 21.6 | 40.6 | 94.6 | 90 |
| composite non- | | | | | | | |
| woven fabric of | | | | | | | |
| Embodiment 3 | | | | | | | |

The degradable composite non-woven fabric produced according to the aforementioned structures and manufacturing method has upper and lower layers made of degradable bi-component fibers in which each strand of fiber has an outer surface containing at least partially a low-melting-point PBAT resin. When heated, the low-melting-point PBAT resin starts to melt, and so fibers in the upper layer can be bond together, and fibers in the lower layer can also be bond together, thereby increasing the bonding strengths of the surface layers respectively. This effectively prevents the escape of the degradable absorbent fibers from the middle fiber layer and the occurrence of fiber “shedding”. In addition, both the upper and lower layers as well as the middle fiber layer of the degradable composite wiping non-woven fabric are made of degradable materials. This allows for waste disposal through landfilling, where the fabric degrades in the soil. The produced carbon dioxide during degradation directly enters into the soil organic matters or is absorbed by plants, without being emitted into the atmosphere, thereby avoiding greenhouse effect.

1: A degradable composite non-woven fabric with a layered structure, comprising sequentially an upper layer, a middle fiber layer, and a lower layer; wherein the upper layer and the lower layer of the degradable composite non-woven fabric are formed by degradable melt-blown fibers, and the middle fiber layer is formed by degradable absorbent fibers; a weight of the middle fiber layer is more than 65% of a total weight of the degradable composite non-woven fabric, and there are fiber interlacing and intertwining areas between the upper layer and the middle fiber layer, as well as between the lower layer and the middle fiber layer.

2: The degradable composite non-woven fabric of claim 1, wherein the degradable melt-blown fibers are fibers made from polylactic acid, polybutylene adipate terephthalate (PBAT), or a mixture thereof.

3: The degradable composite non-woven fabric of claim 1, wherein the degradable melt-blown fibers are degradable single-component fibers, degradable bi-component melt-blown fibers in which each strand of fiber has an outer surface at least partially formed by a low-melting-point resin, or a mixture thereof.

4. (canceled)

5: The degradable composite non-woven fabric of claim 1, wherein the middle fiber layer comprises viscose fibers, wood pulp fibers, or mixed fibers formed by a mixture of the viscose fibers and the wood pulp fibers.

6: The degradable composite non-woven fabric of claim 5, wherein a weight percentage of the viscose fibers in the mixed fibers of the middle fiber layer is greater than or equal to 15%.

7. (canceled)

8. (canceled)
